(19) United States
(12) Patent Application Publication
(10) Pub. No.: US 2022/0234766 A1
(43) Pub. Date: Jul. 28, 2022

(54) ENGINE MODULAR DESIGN AND CONSTRUCTION FOR REDUCED COST AND ACCELERATED DEVELOPMENT, APPLYING A USER-SPECIFIED DESIGN PROCESS

(71) Applicant: Michael J. Patterson, Carrizozo, NM (US)

(72) Inventor: Michael J. Patterson, Carrizozo, NM (US)

(21) Appl. No.: 17/524,401

(22) Filed: Nov. 11, 2021

Related U.S. Application Data
(60) Provisional application No. 63/112,689, filed on Nov. 12, 2020.

(51) Int. Cl. B64G 1/40

(52) U.S. Cl. CPC B64G 1/405

(57) ABSTRACT

A method includes producing an electric propulsion (EP) rocket engine. The method selects a core discharge chamber. A discharge cathode assembly (DCA) is selected along with a DCA common interface (CI). The DCA CI is connected to the core discharge chamber and the DCA is connected to the DCA CI. A neutralizer cathode assembly (NCA) is selected with an NCA CI. The NCA CI is connected to the core discharge chamber and the NCA is connected to the NCA CI. An ion optics assembly (IOA) is selected along with an IOA CI. The IOA CI is connected to the core discharge chamber and the IOA is connected to the IOA CI. The three common interfaces: DCA CI, NCA CI, and IOA CI allow for different subassemblies to be connected to their respective common interfaces—for purposes of re-configurability to accommodate changes in operational requirements, or replacement of subassemblies.

### CROSS-REFERENCE TO RELATED APPLICATIONS

This application claims the benefit of U.S. Provisional Application No. 63/112,689, filed on Nov. 12, 2020 entitled ENGINE MODULAR DESIGN AND CONSTRUCTION FOR REDUCED COST AND ACCELERATED DEVELOPMENT, APPLYING A USER-SPECIFIED DESIGN PROCESS, the contents of which are incorporated herein by reference in its entirety.

### BACKGROUND

An electrically powered spacecraft propulsion system (‘Electric Propulsion’, or EP for short) uses electrical, and possibly also magnetic fields, to accelerate charged particles for purposes of imparting a change in the velocity of a spacecraft. Most of these kinds of spacecraft propulsion systems work by electrically expelling propellant (reaction mass) at high speed. Electrically powered spacecraft propulsion systems are currently very specialized and designed generally one at a time for specialized missions. Electric thrusters use much less propellant than chemical rockets because they have a higher exhaust speed (operate at a higher specific impulse) than chemical rockets. Due to limited electric power the thrust is much weaker compared to chemical rockets, therefore electric propulsion must thrust for longer periods of time to impart a substantial change in spacecraft velocity.

Electric propulsion (EP) rocket engines are now a mature and widely used technology on spacecraft. Russian satellites have used EP for decades. As of 2019, over 500 spacecraft operated throughout the solar system use EP for station keeping, orbit raising, or primary propulsion. In the future, the most advanced electric thrusters may be able to impart a delta-v of 100 km/s, which is enough to take a spacecraft to the outer planets of the solar system (with nuclear power), but is insufficient for interstellar travel. An electric rocket with an external power source (transmissible through laser on the photovoltaic panels) has a theoretical possibility for interstellar flight. However, EP is not suitable for launches from the Earth's surface, as it offers too little thrust and can only operate in a vacuum. On a journey to Mars, an electrically propelled spacecraft might be able to carry 70% of its initial mass to the destination, while a chemical rocket could carry only a few percent. Because electric propulsion systems and the associated operational requirements are complex, EP thrusters are individually custom designed to meet the very specific and demanding mission requirements they are provided to accomplish.

Custom designing a new EP rocket engine essentially for each mission leads to EP thrusters that are too complex and contain too many parts, require too much touch-labor to assemble, take too long to develop and qualify, and are therefore generally too costly to build and field. Traditional EP thrusters cannot be readily reconfigured to accommodate changes in operational requirements and are therefore subject to rapid obsolescence. Custom built EP rocket engines cannot be readily reparable to accommodate issues associated with sub-assembly component infant mortality or out-of-family function. Additionally, traditional EP thrusters are designed, developed, and manufactured as “one-and-done” items without a holistic approach relative to either product-line development, or portfolio development.

An excellent case example is NASA's development of the NSTAR thruster and propulsion system which was successfully flown on Deep-Space 1 and Dawn missions. NSTAR never became a commercially viable product due to its design and cost. It is not presently available for NASA applications because it is not produced by industrial sources; it is an orphaned technology.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, the subject disclosure pertains to a method of producing an electric propulsion (EP) rocket engine. The method selects a core discharge chamber. A discharge cathode assembly (DCA) is selected along with a DCA common interface (CI). The DCA CI is connected to the core discharge chamber and the DCA is connected to the DCA CI. A neutralizer cathode assembly (NCA) is selected and an NCA CI is selected. The NCA CI is connected to the core discharge chamber and the NCA is connected to the NCA CI. An ion optics assembly (IOA) is selected along with an IOA CI. The IOA CI is connected to the core discharge chamber and the IOA is connected to the IOA CI. The three common interfaces: DCA CI, NCA CI, and IOA CI allow for various different NCAs, DCAs, and/or IOAs to be connected to them as discussed further below.

According to another aspect, a system of building an EP rocket engine is provided. The system includes a core discharge chamber, a neutralizer cathode assembly (NCA), a discharge cathode assembly (DCA), and an ion optics assembly (IOA). An NCA common interface (CI) is mounted to the core discharge chamber with the NCA mounted to the NCA CI and a DCA CI is mounted to the core discharge chamber with the NCA mounted to the NCA CI, and an IOA CI is mounted to the core discharge chamber mounted to the core discharge chamber with the IOA mounted to the IOA CI.

In accordance with another aspect, a method executes, on a processor, instructions that cause the processor to perform operations associated with building an EP powered rocket engine. The instructions include selecting a core discharge chamber. The instructions also include selecting a discharge cathode assembly (DCA) with a DCA common interface (CI) used with the core discharge chamber. The instructions further include selecting a neutralizer cathode assembly (NCA) with a NCA CI used with the core discharge chamber. The instructions also include selecting an ion optics assembly (IOA) with an IOA CI used with the core discharge chamber. In some embodiments, the instructions can include causing the EP rocket to be assembled with the selected components.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an example electric rocket engine with common interfaces.

FIG. 2 is an example block diagram of an example family of electric rocket engines with common interfaces.

FIG. 3 is an example block diagram of another example family of electric rocket engines with common interfaces.

FIG. 4 is an example key of FIG. 3 of the block diagram of another example family of electric rocket engines with common interfaces.

FIG. 5 is a flow chart diagram of a method of building an electric rocket engine.

FIG. 6 is a flow chart diagram of another method of building a family of electric rocket engines.

FIG. 7 is a flow chart diagram of another method of building a family of electric rocket engines.

FIG. 8 is a flow chart diagram of another method of building a family of electric rocket engines.

FIG. 9 is a customized “common interface” for a cathode designed based upon a standard conflat flange.

FIG. 10 illustrates a cathode integrated into the “common interface” of FIG. 9.

FIG. 11 is a block diagram illustrating a suitable operating environment for aspects of the subject disclosure.

### DETAILED DESCRIPTION

Electric Propulsion rocket engines provide lower thrust compared to chemical rockets by several orders of magnitude because of the limited electrical power available in a spacecraft. A chemical rocket imparts energy derived from combustion products directly, whereas an EP system requires several steps. However, the high velocity and lower reaction mass expended for the same total impulse allows EP rockets to run on less propellant. This differs from the typical chemical-powered spacecraft, where the engines require more propellant, requiring the spacecraft to mostly follow an inertial trajectory. An EP engine cannot provide enough thrust to lift the vehicle from a planet's surface, and it only operates within the space vacuum, but a low thrust applied for a long interval can impart potentially very large changes in spacecraft velocity.

A system for modular design and construction for electric propulsion (EP) rocket thrusters uses standard/common interfaces for the construction of major components of the EP thruster. Later, specific examples are given for electrostatic (gridded) ion engines, but this approach can be generally applied to different types of EP thrusters. For example four major components of a gridded ion engine include a discharge chamber, a discharge cathode assembly (DCA), an ion optics assembly (IOA), and a neutralizer cathode assembly (NCA). When these components can be designed to each use a common interface (CI), then different versions of these components can be designed using that same interface. Ideally, the common interface will have identical mechanical, electrical, and gas interfaces for each EP rocket engine module. This modular approach provides for a great many different types of EP rocket engines that may be produced from a small group of interchangeable components.

Designing an EP rocket engine with modular components provides for accelerated development time for a new thruster configuration, enhance-and-extend hardware endurance and application, reduces re-qualification requirements, and also enables user-specified thruster configurations optimized for a specific mission application. Using modular components in EP rocket engine design provides for a “select from the catalog” approach by appropriate choice of sub-assemblies. Modular rocket components additionally create a pathway to rapidly develop multiple products emerging from a single initial design and development cycle. This approach facilitates both product line development, and entire portfolios of EP rocket engines that are easy to produce.

An important insight is that the design and construction of an EP thruster can be broken down into sub-assemblies, each sub-assembly having well-defined-and-separable functional attributes.

As an example, and previously mentioned above, for a gridded ion engine the required operational characteristics (“functional attributes”) may be broken down into four essential functions, which may be embodied by four, separable, sub-assemblies as listed in Table 1:

TABLE 1

| Function | Primary Sub-Assembly (SA) |
|---|---|
| Plasma Generation | Discharge Chamber |
| Electron Emission | Discharge Cathode Assembly (DCA) |
| Ion Acceleration | Ion Optics Assembly (IOA) |
| Beam Neutralization | Neutralizer Cathode Assembly (NCA) |

When these sub-assemblies are designed properly, and with the application of common interfaces (CIs), this enables a change-out of particular sub-assemblies (e.g., sub-assembly C Version 1, (SA C1)) with a substitute sub-assembly (e.g., sub-assembly C Version 2, (SA C2)). This both minimizes the impact to the overall thruster design, and enables the overall assembly to accommodate changes in operational requirements.

One configuration is method of producing an electric propulsion (EP) rocket engine. The method begins by selecting a core discharge chamber and selecting a discharge cathode assembly (DCA) from a plurality of different DCAs. A DCA common interface (CI) is designed to fit between the core discharge chamber and the DCA. The DCA CI is adapted to be fitted with each of the plurality of different DCAs. A neutralizer cathode assembly (NCA) is selected from a plurality of different NCAs and an NCA common interface (CI) is designed to fit between the core discharge chamber and the NCA. The NCA CI is adapted to be fitted with each of the plurality of different NCAs. An ion optics assembly (IOA) is selected from a plurality of different IOAs and an IOA common interface (CI) is designed to fit between the core discharge chamber and the IOA. The IOA CI is adapted to be fitted with each of the plurality of different IOAs. The method assembles the EP rocket engine using the core discharge chamber, DCA, DCA CI, NCA, NCA CI, IOA, and IOA CI.

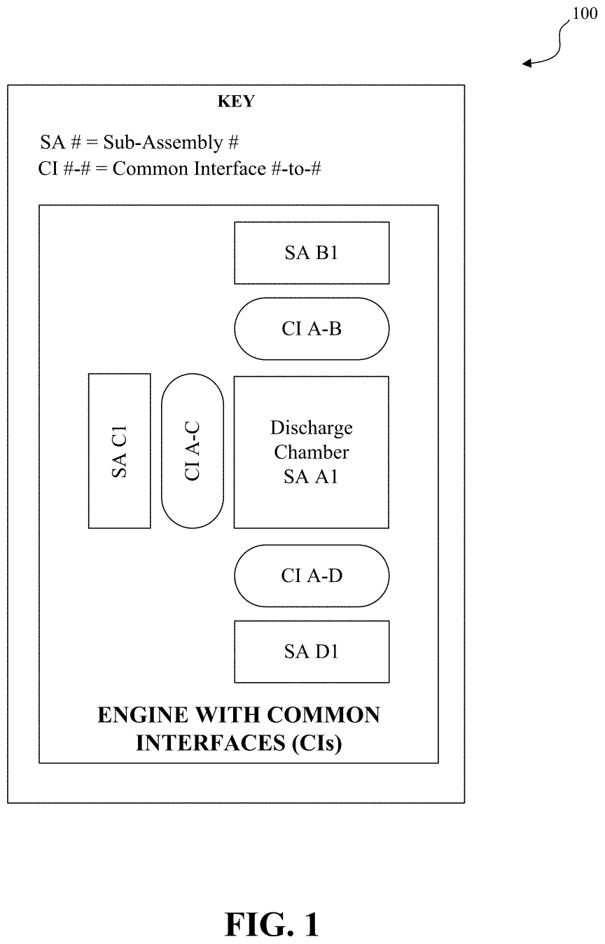

A generalized version of this concept is the example EP rocket engine system 100 illustrated in FIG. 1. More-detailed implementation illustrations are provided in a later section to emphasize unique and novel features of EP rocket engine system 100. With respect to FIG. 1's Reference Key, an engine concept is defined as the composition of four primary sub-assemblies: SA A1, SA B1, SA C1, and SA D1. The sub-assemblies are joined to a common core sub-assembly, SA A1. The SAs are attached to the common core SA A1 with common interfaces (CIs): CI A-B, CI A-C, and CI A-D.

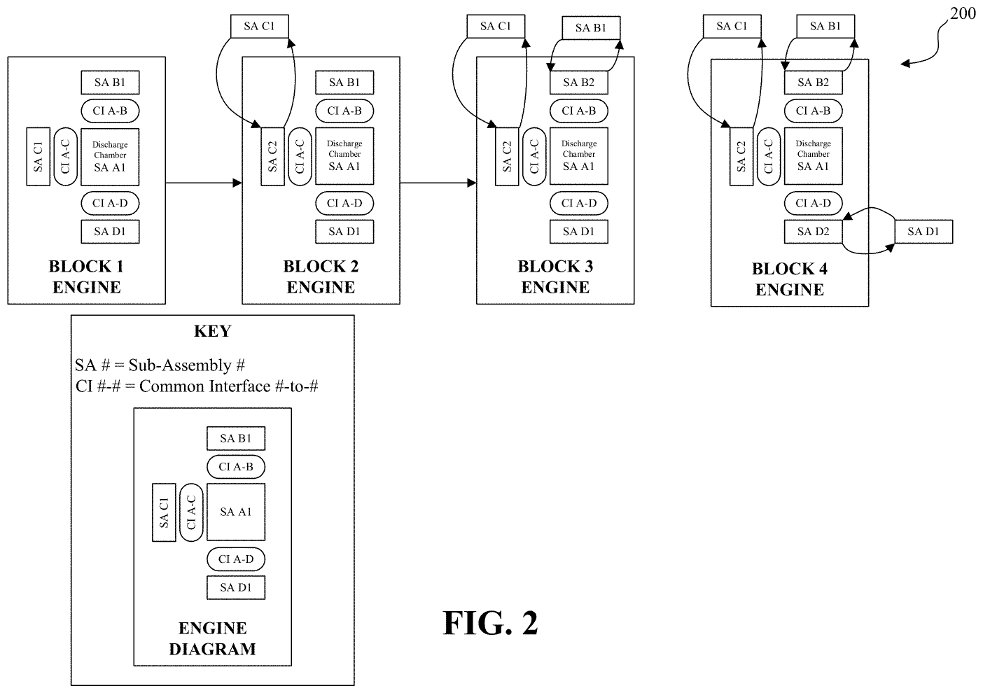

Referring to FIG. 2, different block versions of the base engine concept (Block 1 Engine) are created by the proper substitution of sub-assemblies (with different design features) to yield new Engine Block configurations (Block 2 Engine, Block 3 Engine, and Block 4 Engine) with different operational characteristics. In the system 200 illustrated in FIG. 2, a Block 1 Engine uses sub-assembly (SA) B1, SA C1, and SA D1 coupled to a Discharge Chamber (SA A1) using Common Interfaces (CIs) CI A-B, CI A-C and CI A-D, respectively. Within this system 200, the Block 1 Engine is simply converted to a Block 2 Engine by swapping out Sub-Assembly (SA) C1 and replacing it with SA C2. Similarly, Block 2 Engine is converted to a Block 3 Engine by swapping out SA B1 and replacing it with SA B2. Block 3 Engine is converted to a Block 4 Engine by swapping out SA D1 and replacing it with SA D2.

This “plug-and-play” hardware approach in creating new block engines with common interfaces for similar components accelerates the overall development time for specific engine configurations. These types of block engines enhance and-extend engine emergence/endurance, by accommodating replacement sub-assembly change-outs. Additionally, modularity extends engine applications/applicability, by extending its capabilities to capture new missions via change-out of sub-assemblies with new/different capabilities.

An example includes changing the ion optics assembly (IOA) sub-assembly on an engine from a design optimized for “deep-Space” operations for a NASA mission, to an IOA sub-assembly design optimized for “high thrust-to-power” operations for Earth orbital commercial or national security missions. This feature is particularly important in the context of NASA-funded engine development work which typically yields highly optimized products that are directly applicable to NASA's unique missions—to ensure that products are not orphaned and have applicability beyond the NASA mission set.

Furthermore, building engines reduces re-qualification requirements by leveraging pre-existing, pre-tested, and pre-qualified sub-assemblies. For the end-user this creates the ability to specify an engine design that is optimized for a specific mission application through an appropriate choice of sub-assemblies (e.g., “select from the catalog” approach). For the manufacturer this creates a pathway for rapid maturation of multiple products emerging from a single initial design and development cycle.

While gridded ion engines may be one example application because sub-assemblies are functionally distinct and can be effectively “decoupled” mechanically if properly designed, this approach can be applied to good effect in the design of other EP thruster technologies. Examples include the non-conventional NASA-patented Annular Ion Engine (the “core” sub-assembly of which would be the annular discharge chamber SA); and the Hall-Effect thruster (the “core” sub-assembly of which would be the anode housing SA). Gridded ion engines and Hall-Effect thrusters presently constitute well over 50% of the EP thruster technology inventory flown today.

A modular approach to designing EP engines provides for extensibility of this approach across multiple product lines. As an example, the NCA SA (or DCA SA, depending upon emission current requirements) of a gridded ion engine, can be readily implemented as the cathode assembly (CA) sub-assembly for a Hall-Effect thruster. The functional and lifetime requirements for cathode technology for both types of thrusters in many instances are essentially identical. In previous thruster products, there is a lack of portability of sub-assemblies across different product lines. So long as both engine technologies implement an identical common interface for the cathode to mate to the core sub-assembly, then this singular sub-assembly can be applied with equal effect to either product line.

In this approach, engines are designed so that the engine sub-assemblies are bifurcated into well-defined units-of-hardware according to their functional characteristics. Sub-assemblies can be designed such that the functional capabilities of a single sub-assembly can be replaced to extend overall engine life, or modified to alter or improve the characteristics of the engine with little/no impact on other sub-assemblies. A “core” sub-assembly of the engine (in the case of a gridded ion thruster, the discharge chamber sub-assembly) becomes the primary structural element. With sufficient thermal and structural margins, the core forms the base element of a “reconfigurable architecture.” As described in more detail later, applying a “common interface” design approach to the sub-assembly interfaces enables a “plug-and-play” reconfigurable architecture (described in more detail later).

Creating a user-specific engine design process enables the development of engine products optimized for specific mission applications. This is because adopting a user-specified engine design process facilitates (drives) the definition of the required sub-assemblies which are necessary to create application-optimized engine products. Another way of stating this is: “This system ensures that the manufacturer only builds products which customers are interested in.”

Using modular electric powered engine thrusters based on common interfaces enables a holistic approach to engine design and build; facilitating not just product-line development, but facilitating development of entire portfolios of products. Common Interfaces (CIs) also enable the interchangeability of sub-assemblies to modify the characteristics of the overall engine.

The concept of a CI can be implemented in two fashions. In one manner an interface design between a sub-assembly “A” and a “Core” sub-assembly (in the case of a gridded ion engine, the discharge chamber SA being the “core”) is specified by an Interface Control Drawing (ICD) which is simply applied to all versions of the sub-assembly “A” and the Core sub-assembly mating surfaces. A second approach—in addition to being specified by an ICD—the CI is manifested as a physical part, which provides all mating interfaces (mechanical, electrical, and propellant) to transfer structural loads, electrical power, and propellant as might be required.

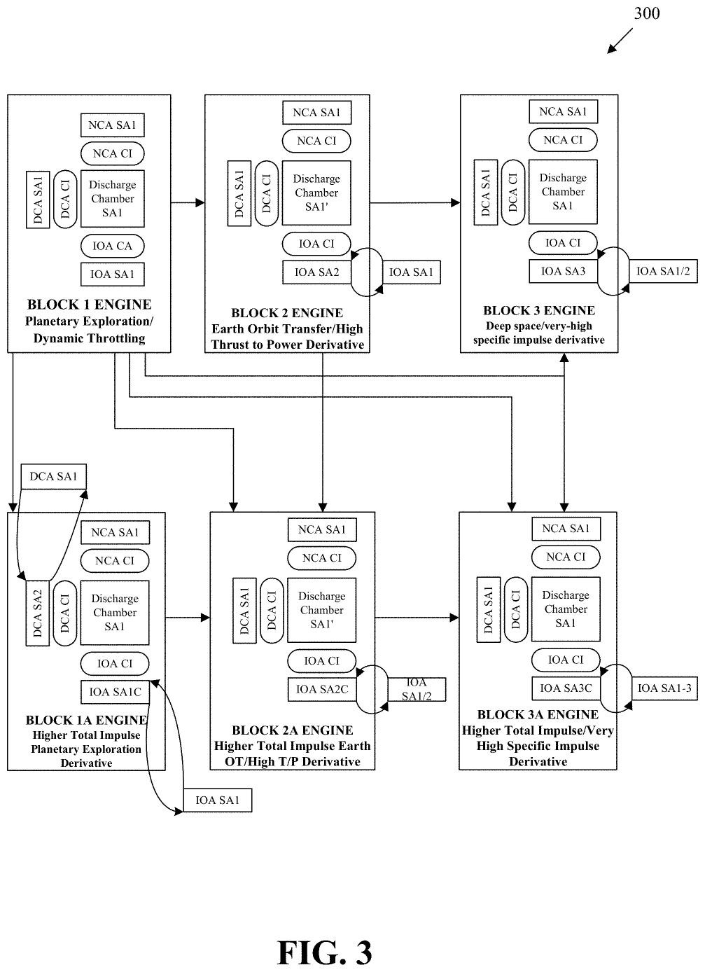

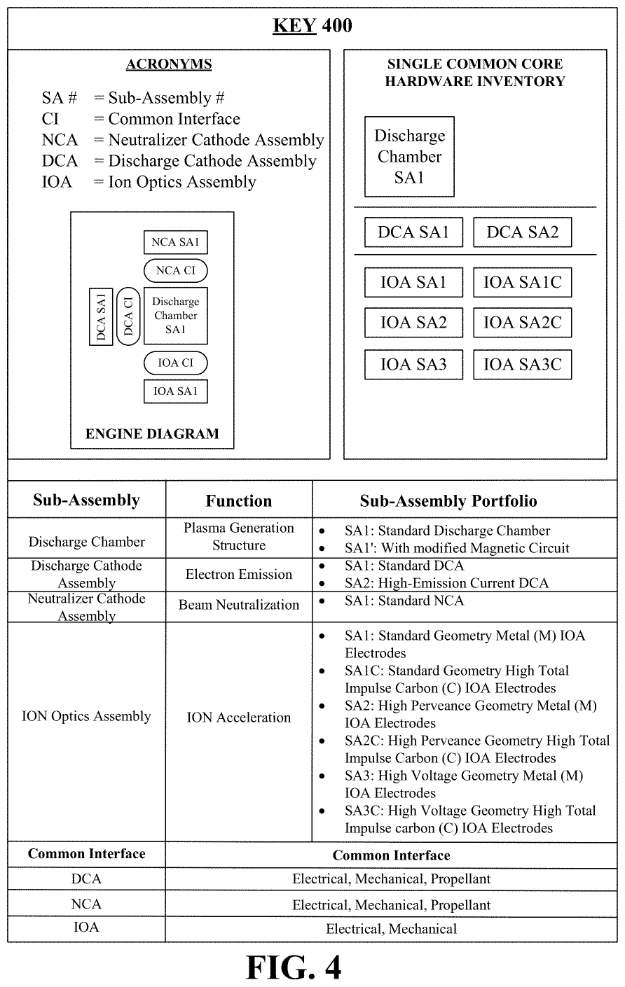

FIG. 3 illustrates and example system 300 of creating different versions of an EP engine (e.g., a “product line”) based upon the concept of a single common core sub-assembly. This figure illustrates an example application is provided for gridded ion engines. A notional “hardware inventory’” of sub-assemblies used is provided FIG. 3's Key 400 as illustrated in FIG. 4. In this example, a single common core sub-assembly discharge chamber SA1—is used to create a product line of five separate example engines derived from one original engine configuration, the Block 1 Engine.

In one instance, the notional Block 1 Engine is designed for planetary exploration, with a dynamic throttling range. That is, it has similar mission requirements to that of NASA's NSTAR and NEXT thrusters.

In another configuration, the Block 1 Engine, with minor modification, is upgraded to a Block 1A Engine (High Total Impulse Planetary Exploration Derivative)—with higher peak power range and greater total impulse capability as compared to Block 1. The Block 1A Engine substitutes a ion optics assembly (IOA) SA1 standard geometry fabricated from metal (M) electrodes for one fabricated from carbon (C) electrodes; IOA SA1 C. An adjustment to accommodate higher power, if required, is made by the substitution of the discharge cathode assembly (DCA) (DCA SA1 is substituted for DCA SA2) to a higher-emission current design.

In another instance, the Block 1 Engine, with minor modification, is upgraded to a Block 2 Engine (Earth Orbit-Transfer/High Thrust-to-Power Derivative). This design has higher thrust-to-power operation as compared to Block 1, by the substitution of the ion optics assembly (IOA) SA1 standard geometry metal electrode design to one with higher perveance (higher current extraction capability, to yield higher thrust for a given input power) electrode design; IOA SA2. This may be accomplished with or without a minor adjustment in the magnetic circuit of the “core” discharge chamber SA1 resulting in discharge chamber SA1′.

In another situation, the Block 2 Engine, with minor modification, could be upgraded to a higher total impulse capability, the Block 2A Engine (Higher Total Impulse Earth Orbit-Transfer/High Thrust-to-Power Derivative). This is done by changing the ion optics assembly (IOA) electrode material in the IOA SA2 design from metal to carbon resulting in the IOA SA2C design.

In another configuration, the Block 1 or Block 2 Engines, with minor modification, could be changed to a very-high specific impulse design, the Block 3 Engine (Deep Space Very-High Specific Impulse Derivative). This is easily performed by substitution of the existing IOA electrode designs to one operating at higher voltage (correspondingly, higher specific impulse); the IOA SA3 design.

The Block 3 Engine, with minor modification, could be upgraded to a higher total impulse capability, the Block 3A Engine (Higher Total Impulse Deep Space Very-High Specific Impulse Derivative). In one example, this is accomplished by changing the electrode material in the IOA SA3 design from metal to carbon; the IOA SA3C design.

Traditionally, when designing EP thrusters, the processes was similar to the design and used of expendable launch vehicles. Generally, a launch vehicle was created and used and then everything is thrown away and a new design is started from scratch. In this new approach to designing EP thrusters with common interfaces, one applies maximum-leverage to prior investments to create an entire portfolio of engines.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished following either a push and/or pull control model. The components may also interact with one or more other components not specifically described herein for the sake of brevity but known by those of skill in the art.

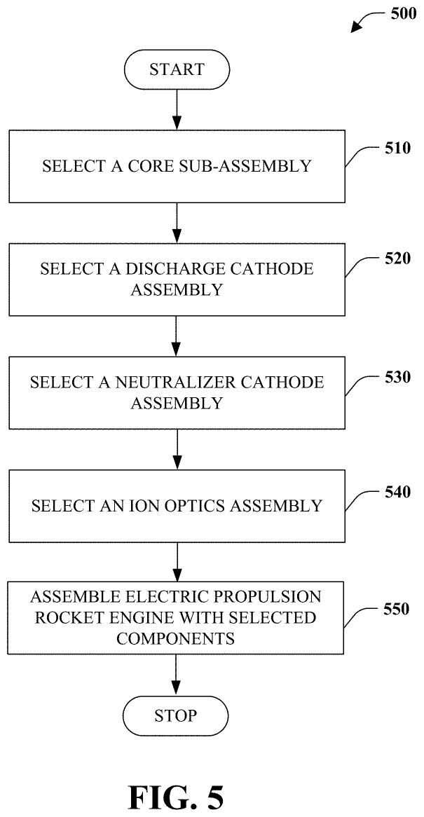

In view of the example systems described above, methods that may be implemented in accordance with the disclosed subject matter will be better appreciated with reference to flow chart diagrams of FIGS. 5-8. While for purposes of simplicity of explanation, the methods are shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 5, a method 500 of building an electric propulsion (EP) engine is depicted in accordance with an aspect of this disclosure.

At reference numeral 510, a core assembly is selected. For example for gridded ion engines, a portfolio a portfolio of three (3) discharge chambers/common cores engines should be sufficient. The portfolio may include three (3) discharge chambers of various diameters corresponding to different power ranges. In one embodiment, the discharge chamber to select from includes a “small” discharge chamber that operates between about 0.5 kW and 5.0 kW power levels with a nominal diameter of 20 cm. In another instance, if an “intermediate” discharge chamber is desired with a 5-20 kW operation level, then the intermediate chamber may be selected with a nominal diameter of 40 cm. Otherwise, if a larger discharge chamber is desired, a 20-100 kW powered “large” chamber with a nominal diameter of 60 cm or equivalent may be selected.

At reference numeral 520, a discharge cathode assembly (DCA) is selected. In one embodiment, the DCA may be selected from three (3) DCAs of different sizes for different emission current ranges. For lower power, DCA-1 for low emission currents built from ⅛″ diameter built with hollow cathode technology may be selected. For intermediate emission currents, a DCA-2 built with ¼″ diameter technology and hollow cathode technology may be selected. For large emission currents a DCA-3 for high emission currents built with ½″ diameter hollow cathode technology be selected. Of course, other DCAs may be selected as understood by those of ordinary skill in the art.

At reference numeral 530, a neutralizer cathode assembly (NCA) is selected. In one instance, one of two (2) NCAs of different sizes for different emission current ranges is selected. In one instance, for low emission currents, NCA-1 built from ⅛″ diameter hollow cathode technology may be selected. For intermediate and high emission currents, NCA-2 built from ¼″ diameter hollow cathode technology may be selected.

At reference numeral 540, an ion optics assembly (IOA) is selected. In one embodiment one of three (3) optics electrode geometries may be selected depending on the application. For example, a “standard-01”, a “high thrust-to-power-02”, or a “high specific impulse-03” IOA may be selected. Each of these IOAs my further consist of two (2) different electrode materials “M” for metal, or “C” for carbon based upon total-impulse requirements.

At element 550, the EP engine is assembled. The EP rocket engine is assembled with the components selected in reference numerals 510, 520, 530, and 540 using the corresponding common interface.

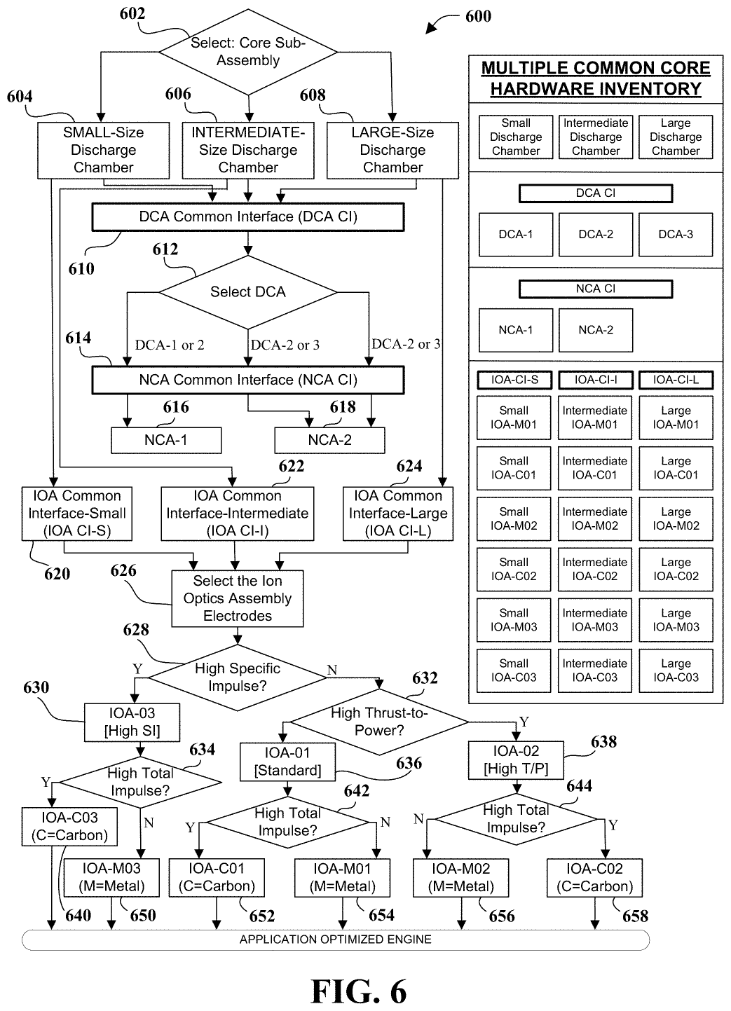

Turning to FIG. 6, a method 600 of building electric propulsion rocket thrusters/engines is depicted in accordance with an aspect of this disclosure. The method 600 can be performed by the EP rocket engine system 200 of FIG. 2. The method 600 uses common interfaces between the components selected in FIG. 6.

At reference numeral 602, a core sub-assembly having common interfaces is selected. The common interfaces (CIs) enable the interchangeability of sub-assemblies to modify the characteristics of the overall engine. The concept of a CI can be implemented in two fashions, as previously mentioned. In one manner, an interface design between a sub-assembly “A” and a core sub-assembly (in the case of a gridded ion engine, the discharge chamber SA being the “core”) is specified by an interface control drawing (ICD) which is simply applied to each version of the sub-assembly “A” and the core sub-assembly mating surfaces. A second approach, in addition to being specified by an ICD, the CI is manifested as a physical piece-part, which provides all mating interfaces (mechanical, electrical, and propellant) to transfer structural loads, electrical power, and propellant as might be required.

The right hand side of FIG. 6 illustrates an example notional “Multiple Common Core Hardware Inventory” of the sub-assemblies used in example FIG. 6. By using one of multiple common cores it is possible to build virtually all foreseeably required engine products—over at least a 200:1 range in input power—simply from a modest assemblage of subassemblies, through proper design, selection, and the application of common Interfaces. In this example FIG. 6, labels for the various sub-assemblies are modified from previously illustrations to be more “user-friendly”, reflecting differences in functional characteristics such as size or materials used.

Specifically for gridded ion engines, this portfolio development is achieved from the combination of three (3) Common Cores and three (3) discharge chambers of various diameters corresponding to different power ranges. Based on the decision at 602, one of the three common core is selected at blocks 604, 606, or 608.

For example, at block 604, a small common core may be selected that operates between a 0.5 kW-5.0 kW power level with a nominal diameter of a 20 cm. Alternatively, at 406, an intermediate core may be selected that operates between 5-20 kW with a nominal diameter of 40 cm or, at 608, a large core may be selected that operates between 20-100 kW with a nominal diameter of 60 cm.

At instance 610, a decision is made to select a discharge cathode assembly (DCA). In this example embodiment, one of three (3) DCAs of different sizes for different emission current ranges may be selected and one is selected at reference numeral 612. As illustrated, DCA-1 or 2 for low emission currents built from ⅛″ hollow cathode technology may be selected. Alternatively, DCA-2 or 3 can be selected for intermediate emission currents built using ¼ diameter hollow cathode technology or DCA-3 can be selected for high emission currents built from ½″ hollow cathode technology.

The DCA common interface (CI) is selected, at reference numeral 614, would also provide the propellant feed from the discharge chamber SA to the DCA SA. All three aforementioned DCA SA designs could employ ⅛″ diameter stainless steel tubing (e.g.) for the propellant lines—making it a straightforward mechanical implementation regardless of cathode size. This DCA CI would then enable complete interchangeability of a DCA SA with another discharge chamber SA.

At instance 614, one of two (2) neutralization cathode assemblies (NCAs) of different sizes for different emission current ranges may be selected. NCA-1, selected at reference numeral 616, provides for low emission currents built and is built from ⅛″ diameter hollow cathode technology. NCA-2, selected at reference numeral 618, provides for intermediate or high emission currents and is built with ¼″ diameter hollow cathode technology is selected. In this instance, a high total impulse is desired, and as discussed below drives the electrode material selection to carbon.

The neutralizer cathode assembly common interface (NCA CI) provides the design definition for the interface (structural, electrical, propellant) between different NCA sub-assembly (NCA SA) design and different engines, exterior to the discharge chamber sub-assembly (SA) design. The NCA CI provides electrical isolation between the isolated NCA SA and the spacecraft-common potential. The NCA CI would include the electrical conductors to transfer the electrical power from the NCA SA to the engine harness with proper isolation. The electrical conductors within the NCA CI would be sized to support the maximum current requirement defined by the largest NCA SA design (¼″ cathode). This NCA CI would then enable interchangeability of either selected NCA SA to suitable engine size housings.

Reference number 620, indicates that when the SMALL-Size Discharge Chamber is selected, at reference number 604, then an IOA Common Interface-Small Ion Optics Assembly ((IOA) CI-S) is selected. When the INTERMEDIATE-Size Discharge Chamber is selected, at 606, then an IOA Common Interface-Small (IOA CI-S) is selected, at reference number 622 and when the LARGE-Size Discharge Chamber is selected, at reference number 608, then an IOA Common Interface-Large (IOA CI-S) is selected, at reference number 624.

At reference number 626, an ion optics assembly electrode geometry is selected based on a few decisions. The electrodes may be selected based on three (3) optics electrode geometries, for different applications (“Standard”—01. “High Thrust-to-Power”—02, and “High Specific Impulse”—03) and further consisting of two (2) different electrode materials (‘M’ for metal, or “C” for carbon) based upon total impulse requirements.

If, at reference numeral 628, there is a requirement for a high specific impulse, then a high specific impulse assembly (IOA-03 [high S/I]) is selected, at reference numeral 630. If there is no need at reference numeral 628 for a high specific impulse, then a decision is made at reference numeral 632 if there is a requirement for a high thrust-to-power. If there is a requirement for a high thrust-to-power, then an IOA-02 with a high thrust-to-power [high T/P] is selected, at reference number 638; otherwise an IOA-01 [standard] with a standard power is selected, at reference number 636.

Next, electrodes are selected based on geometry patterns required as well as whether a high total impulse is needed, or not. For example, if an IOA-03 [high S/I] is selected at reference number 630, and a high total impulse is determined at 634, then an IOA-C03 for carbon electrodes of a high specific impulse geometry pattern is selected at instance 640. If a high total impulse is not determined at 634, then an IOA-M03 for metal electrodes of a high specific impulse geometry pattern is selected at instance 650.

Similarly, if an IOA-02 [high T/P] is selected at reference number 638, and a high total impulse is determined at 644, then an IOA-M03 for carbon electrodes of a high specific impulse geometry pattern is selected at numeral instance 658. If a high total impulse is not determined at 644, then an IOA-M03 for metal electrodes of a high specific impulse geometry pattern is selected at instance 656. Likewise, if an IOA-02 [standard] is selected at reference number 636, and a high total impulse is determined at 642, then an IOA-C01 for carbon electrodes of a standard geometry pattern is selected at numeral instance 652. If a high total impulse is not determined at 642, then an IOA-M01 for metal electrodes of a standard geometry pattern is selected at instance 654.

As mentioned previously, common interfaces (CI's) enable the interchangeability of sub-assemblies to modify the characteristics of the overall engine. With reference again to FIG. 3, including the “Multiple Common Core Hardware Inventory” key, example implementations of the common interfaces, as a piece-parts, to a gridded ion engine are reviewed.

The discharge chamber SA is the core SA from which the engine is built. Other primary sub-assemblies mechanically interface to the discharge chamber SA through their respective common interfaces. In one proposed process, a total of three (3) core SA's are employed.

The discharge cathode assembly common interface (DCA C1) provides the design definition for the interface (structural, electrical, propellant) between different DCA sub-assembly (DCA SA) designs and different discharge chamber sub-assembly (SA) designs.

The discharge cathode assembly (DCA) CI provides the design definition for the interface (structural, electrical, propellant) between different DCA sub-assembly (DCA SA) designs and different discharge chamber sub-assembly (SA) design. A properly designed DCA SA can accommodate an emission current range of at least 4:1. This in turn can enable an engine dynamic power range of at least 10:1. As indicated in FIG. 6 three separate DCA SA designs—based on ⅛″ (DCA-1), ¼″ (DCA-2), and ½″ (DCA-3) cathode technologies—can support engine designs ranging in at least 200:1 in input power. The three aforementioned DCA SA designs would range in mass from about 125 gm for the ⅛″ cathode to about 500 gm for the ½″ cathode.

A single common flange and bolt-hole pattern could be designed to structurally support the DCA SA's regardless of cathode mass or size—without being ‘improperly-large’ for the smallest DCA SA nor ‘too small’ for the largest DCA SA. Discharge chamber SAs—regardless of size—would then also have the same common flange-interface and bolt-hole pattern to accommodate mechanical installation of different DCA SA sizes.

The DCA CI would also provide electrical isolation between the (any) cathode-potential DCA SA and the (any) anode-potential discharge chamber SA. The DCA CI would include the electrical conductors to transfer the electrical power from the DCA SA to the discharge chamber SA and into the engine harness with proper isolation. The electrical conductors would be sized to support the maximum current requirement defined by the largest DCA SA design (½″ cathode).

The DCA CI would also provide the propellant feed from the discharge chamber SA to the DCA SA. The three aforementioned DCA SA designs could employ ⅛″ diameter stainless steel tubing for the propellant lines—making it a straightforward mechanical implementation regardless of cathode size. This DCA CI would then enable complete interchangeability of the DCA SA with different discharge chamber SA.

The neutralizer cathode assembly common interface (NCA CI) provides the design definition for the interface (structural, electrical, propellant) between different NCA sub-assembly (NCA SA) designs and different engine, exterior to the discharge chamber sub-assembly (SA) designs. As indicated in FIG. 6, two NCA SA's—based on ⅛″ (NCA-1) and ¼″ (NCA-2) cathode technologies—should be needed to support a 200:1 range in input power. Masses for these designs would range from about 125 gm to 250 gm.

A single clamshell clamp and bolt-hole pattern could be designed to structurally support either NCA SA being attached to different engine exteriors. Engines—regardless of size—would have the same common bolt-hole pattern to accommodate mechanical installation of either NCA SA size.

The NCA CI provides electrical isolation between the isolated NCA SA and the spacecraft-common-potential engine housing. The NCA CI would include the electrical conductors to transfer the electrical power from the NCA SA to the engine harness with proper isolation. The electrical conductors within the NCA CI would be sized to support the maximum current requirement defined by the largest NCA SA design (¼″ cathode).

The NCA CI would also transfer the propellant feed from the NCA SA to the spacecraft interface. Both aforementioned NCA SA designs could employ ⅛″ diameter stainless steel tubing for the propellant lines—making it a straightforward mechanical implementation regardless of size. This NCA CI would then enable interchangeability of either NCA SA to different engine size housings.

The ion optics Assembly common Interface (IOA CI) provides the design definition for the interface (structural, electrical) between the IOA sub-assembly (IOA SA) and the discharge chamber SA. The IOA CI would standardize the structural interface between the IOA SA and the discharge chamber SA, including a common bolt-hole pattern for mechanical attachment of the IOA SA to the discharge chamber SA. The IOA CI would also provide electrical isolation between the IOA SA and the discharge chamber SA. The IOA CI would include the electrical conductors for application of high voltage to the electrodes from the DCA SA power feed. The electrical conductors are sized to support the maximum current requirement defined by the engine size.

The IOA CI is a somewhat more complex implementation than the other CI's since the IOA SA comes in three sizes. Therefore, as illustrated in FIG. 6 the IOA CI comes in three different diameters—based upon the selected size of the core Sub-Assembly (SMALL-size, INTERMEDIATE-size, or LARGE-size Discharge Chamber). Different IOA CI designs would be invariant to changes in IOA SA electrode designs (whether applying high specific impulse, high thrust-to-power, or standard geometries) or to changes in the IOA SA electrode materials (whether metal for standard total impulse, or carbon for high total impulse).

The IOA SA itself (-S, -I, or -L) would employ a common interface (CI) in the design of the electrode mounting system to accommodate selection-or-change-out of various electrode designs (standard, high thrust-to-power, high specific impulse) and electrode materials (metal, or carbon), depending upon engine application. A common design in insulators, shadow shields, and stiffener rings—composing the non-electrode elements of the IOA SA—would be implemented regardless of electrode design or electrode material.

With reference to FIG. 6, the process illustrated enables a user (end customer), to create an application-optimized engine. That is, a user would be able to create a specific engine product that is optimized for their mission application. This is accomplished through a process of decision-making and appropriate choice of sub-assemblies available within a defined, pre-qualified, hardware inventory.

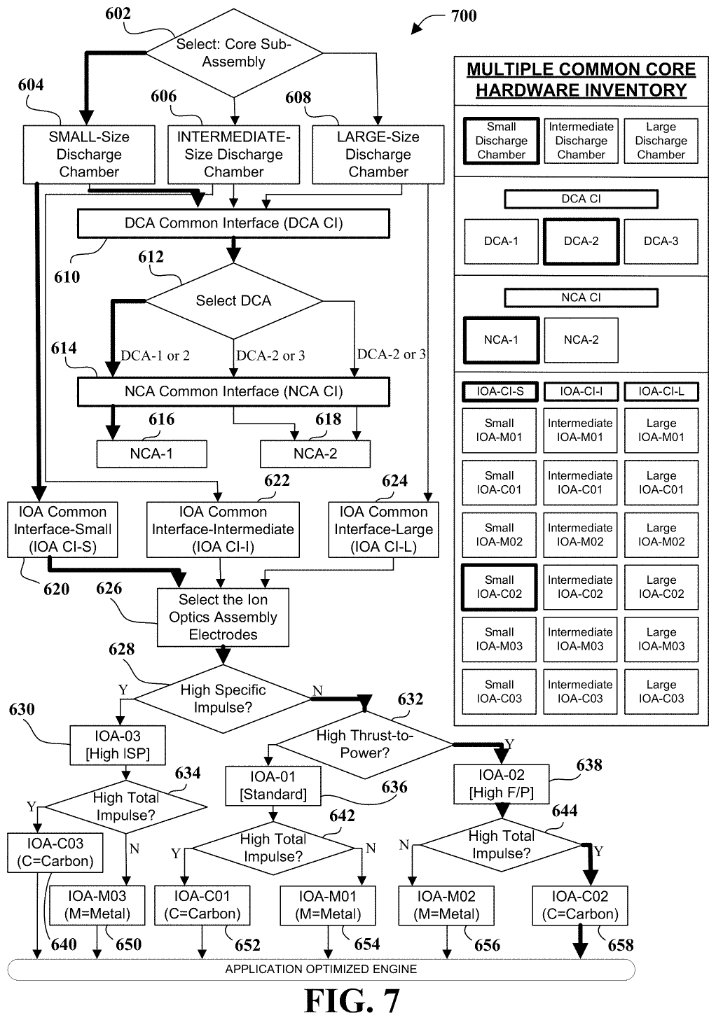

FIG. 7 may be used to design an optimized engine, using one distinct case design. In example 1 illustrated in FIG. 7, a first example of applying a user-specified design process (as shown by the darkened line) to yield a 5 kW Earth-orbital engine. The required sub-assemblies to build this engine are highlighted boxes within the “MULTIPLE COMMON CORE HARDWARE INVENTORY” key in the illustration.

In this instance, a small-size, relatively low-power (<=5 kW) engine is desired. This results in the selection of a SMALL-Size Discharge Chamber as the core sub-assembly; nominally 20 cm diameter. The DCA Common Interface would be installed onto the chamber, accommodating different possible DCA SA selections. Because the emission currents requirements at 5 kW are relatively modest, a DCA-2 SA, based on ¼″ cathode technology, is appropriate and would be selected.

The NCA Common Interface would then be installed onto the chamber, accommodating again different NCA SA selections. For this example, an NCA-1 SA is chosen, based upon ⅛″ cathode technology—to maximize overall electrical performance of the engine.

Because the smallest size Discharge Chamber was selected, the IOA CI-S would be applied—with a diameter matching the IOA and the Discharge. The selection of the IOA electrodes is driven by the mission application. Earth-orbital applications typically optimize at maximum thrust-to-power ratio; hence a high thrust-to-power electrode design (a high perveance—meaning, high current density at low total voltage design) is selected. In this instance a high total impulse is desired, which drives the electrode material selection to carbon.

The end product is a 5 kW-Class high thrust-to-power long-life engine—constructed from a small core, utilizing appropriately sized cathodes, employing high-perveance design carbon-based ion optics electrodes to maximize thrust and life time.

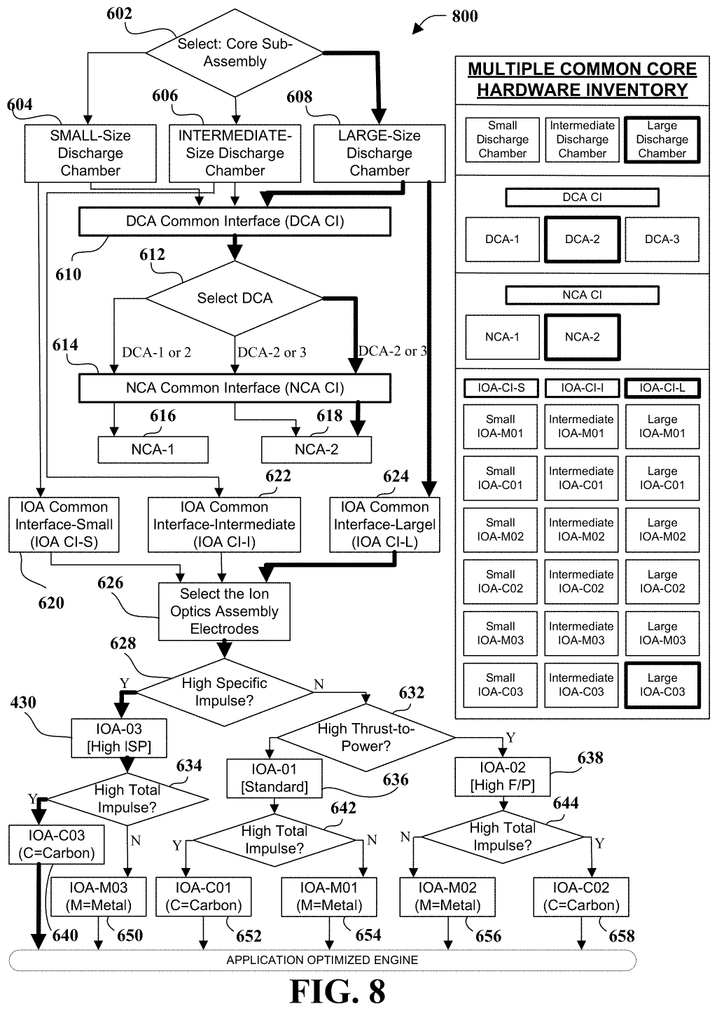

Example in FIG. 8 illustrates applying a user-specified design process to yield a 50 kW deep-space engine. FIG. 8 repeats the illustration of FIG. 7 but with the superposition of a ‘flow-path’ (shown by a darkened line) concluding with the desired product: a large 50 kW-class engine designed for deep-space applications. The required sub-assemblies to build this engine are highlighted in bold boxes within the “MULTIPLE COMMON CORE HARDWARE INVENTORY” key in the illustration.

In this instance, a large-size, high-power (50 kW) engine is desired. This results in the selection of a LARGE-Size Discharge Chamber as the Core sub-assembly; nominally 60 cm diameter. The DCA Common Interface would be installed onto the chamber, accommodating different possible DCA SA selections. Because the emission currents requirements at 50 kW at high specific impulse are moderate, a DCA-2 SA, based on ¼″ cathode technology, is appropriate and would be selected.

The NCA Common Interface would then be installed onto the chamber, accommodating again different NCA SA selections. For this example, an NCA-2 SA is chosen, based upon ¼″ cathode technology—to accommodate the required emission current.

Because the largest size discharge chamber was selected, the IOA CI-L would be applied—with a diameter matching the IOA and the discharge. The selection of the IOA electrodes is driven by the mission application. Deep-space applications require very high specific impulse; hence a High Voltage electrode design is selected. In this instance a high total impulse is also desired, which drives the electrode material selection to carbon.

The end product is a 50 kW-Class high specific impulse long-life engine—constructed from a large core, utilizing appropriately sized cathodes, employing high-voltage design carbon-based ion optics electrodes to maximize specific impulse and life time.

In other instances, hardware for low-cost cathode for commercial applications may be designed as fully-integrated into a commercial-standard Conflat 2¾″ diameter vacuum flange. This “cathode-integrated-into-a-standard flange” allows the cathode to be installed as a self-contained assembly onto different sized vacuum facility chambers. Stated another way, the cathode on a standard flange may be analogous to a DCA on a DCA CI—with the vacuum tank being analogous to a thruster common core/the discharge chamber.

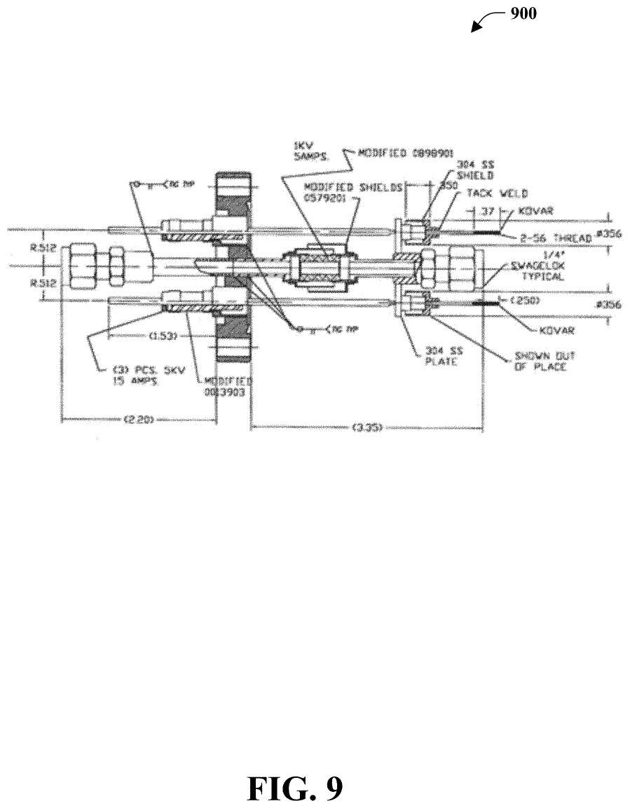

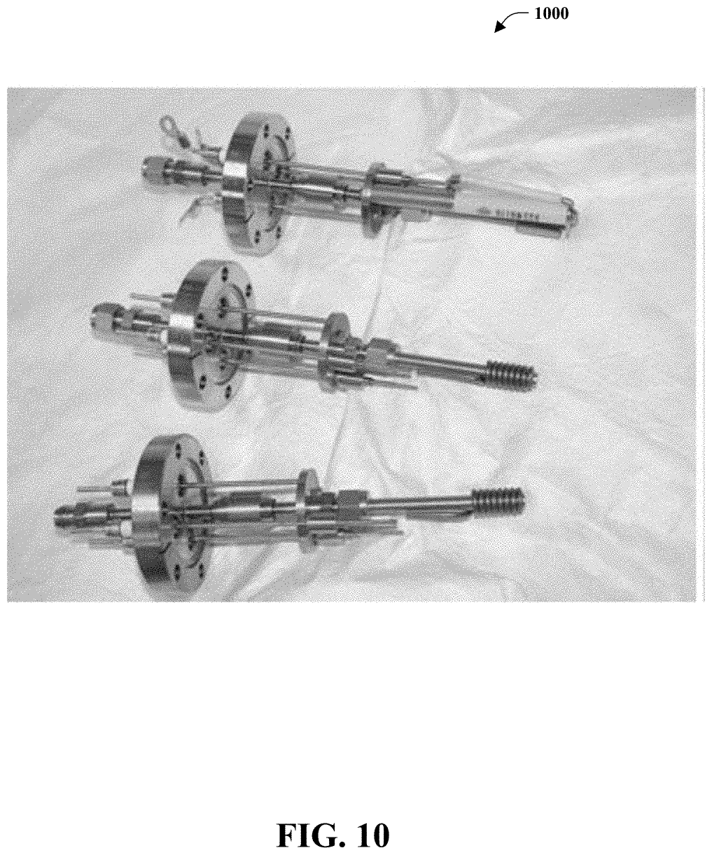

FIG. 9, shows the customized “common interface” for a cathode 900 designed based upon a standard conflat flange. FIG. 10 illustrates a cathode 1000 integrated into the “common interface” of FIG. 9. These cathodes can be installed directly into different vacuum facility chambers that use standard conflat 2¾″ flanges. FIG. 9. Illustrates a common interface concept as applied to a conflat 2¾″ Flange for a Cathode 900. FIG. 10 illustrates example cathodes 1000 integrated into the common interface flange.

If cathodes for EP thrusters apply a similar design approach to this hardware—meaning, integrated into a standard flange (or common Interface) which provides electrical isolation, power, and gas then different cathode assemblies could be installed into different engine discharge chambers. A common interface could be extended to essentially all engine subassemblies, allowing for sub-assembly change-out for repair, replacement, inspection, and/or upgrade. This approach would enable a user-specified sub-assembly selection to optimize an engine for a specific application. The concept would also be extensible across different EP thruster technologies.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished following either a push and/or pull control model. The components may also interact with one or more other components not specifically described herein for the sake of brevity but known by those of skill in the art.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

As used herein, the term “infer” or “inference” generally refer to the process of reasoning about or inferring states of a system, a component, an environment, or a user from one or more observations captured by way of events or data, among other things. Inference may be employed to identify a context or an action or may be used to generate a probability distribution over states, for example. An inference may be probabilistic. For example, computation of a probability distribution over states of interest can be based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several events and data sources.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

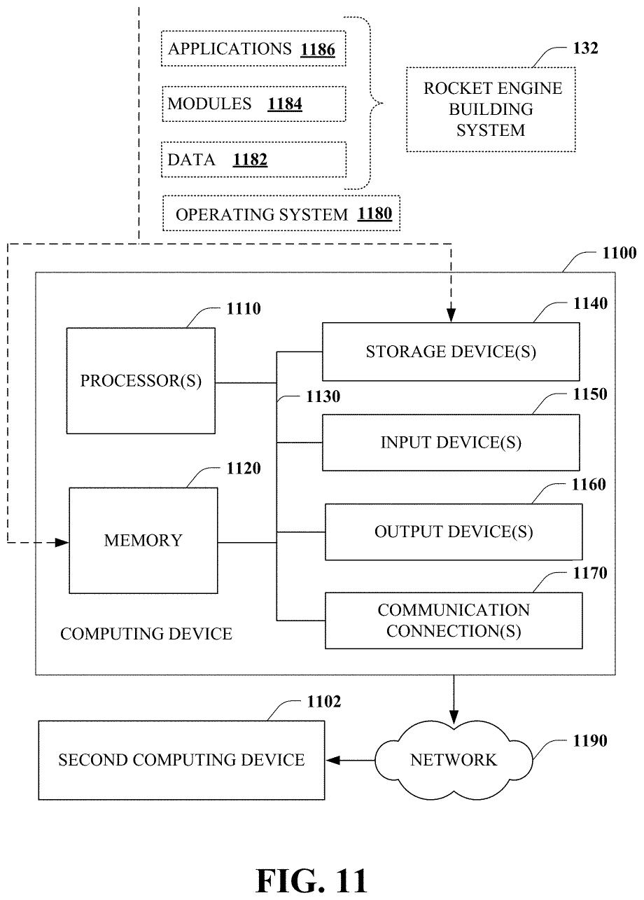

To provide a context for the disclosed subject matter, FIG. 11, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 11, illustrated is an example computing device 1100 (e.g., desktop, laptop, tablet, watch, server, hand-held, programmable consumer or industrial electronics, set-top box, game system, compute node, . . . ). The computing device 1100 includes one or more processor(s) 1110, memory 1120, system bus 1130, storage device(s) 1140, input device(s) 1150, output device(s) 1160, and communications connection(s) 1170. The system bus 1130 communicatively couples at least the above system constituents. However, the computing device 1100, in its simplest form, can include one or more processors 1110 coupled to memory 1120, wherein the one or more processors 1110 execute various computer-executable actions, instructions, and or components stored in the memory 1120.

The processor(s) 1110 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1110 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 1110 can be a graphics processor unit (GPU) that performs calculations concerning digital image processing and computer graphics.

The computing device 1100 can include or otherwise interact with a variety of computer-readable media to facilitate control of the computing device to implement one or more aspects of the disclosed subject matter. The computer-readable media can be any available media accessible to the computing device 1100 and includes volatile and non-volatile media, and removable and non-removable media. Computer-readable media can comprise two distinct and mutually exclusive types: storage media and communication media.

Storage media includes volatile and non-volatile, removable and non-removable media implemented in methods or technologies for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 1100. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 1120 and storage device(s) 1140 are examples of computer-readable storage media. Depending on the configuration and type of computing device, the memory 1120 may be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 1100, such as during start-up, can be stored in non-volatile memory, while volatile memory can act as external cache memory to facilitate processing by the processor(s) 1110, among other things.

The storage device(s) 1140 include removable/non-removable, volatile/non-volatile storage media for storage of vast amounts of data relative to the memory 1120. For example, storage device(s) 1140 include, but are not limited to, one or more devices such as a magnetic or optical disk drive, floppy disk drive, flash memory, solid-state drive, or memory stick.

Memory 1120 and storage device(s) 1140 can include, or have stored therein, operating system 1180, one or more applications 1186, one or more program modules 1184, and data 1182. The operating system 1180 acts to control and allocate resources of the computing device 1100. Applications 1186 include one or both of system and application software and can exploit management of resources by the operating system 1180 through program modules 1184 and data 1182 stored in the memory 1120 and/or storage device(s) 1140 to perform one or more actions. Accordingly, applications 1186 can turn a general-purpose computer 1100 into a specialized machine in accordance with the logic provided thereby.

All or portions of the disclosed subject matter can be implemented using standard programming and/or engineering techniques to produce software, firmware, hardware, or any combination thereof to control the computing device 1100 to realize the disclosed functionality. By way of example and not limitation, all or portions of a rocket engine building system 132 can be, or form part of, the applications 1186, and include one or more modules 1184 and data 1182 stored in memory and/or storage device(s) 1140 whose functionality can be realized when executed by one or more processor(s) 1110.

In accordance with one particular embodiment, the processor(s) 1110 can correspond to a system on a chip (SOC) or like architecture including, or in other words integrating, both hardware and software on a single integrated circuit substrate. Here, the processor(s) 1110 can include one or more processors as well as memory at least similar to the processor(s) 1110 and memory 1120, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the rocket engine building system and/or functionality associated therewith can be embedded within hardware in a SOC architecture.

The input device(s) 1150 and output device(s) 1160 can be communicatively coupled to the computing device 1100. By way of example, the input device(s) 1150 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 1160, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 1150 and output device(s) 1160 can be connected to the computing device 1100 by way of wired connection (e.g., bus), wireless connection (e.g., Wi-Fi, Bluetooth, . . . ), or a combination thereof.

The computing device 1100 can also include communication connection(s) 1170 to enable communication with at least a second computing device 1102 utilizing a network 1190. The communication connection(s) 1170 can include wired or wireless communication mechanisms to support network communication. The network 1190 can correspond to a local area network (LAN) or a wide area network (WAN) such as the Internet. The second computing device 1102 can be another processor-based device with which the computing device 1100 can interact. In one instance, the computing device 1100 can execute a rocket engine building system 132 for a first function, and the second computing device 1102 can execute a system of building and electric rocket engine for a second function in a distributed processing environment. Further, the second computing device can provide a network-accessible service that stores source code, and encryption keys, among other things that can be employed by the a rocket engine building system 132 executing on the computing device 1100.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of producing an electric propulsion (EP) rocket engine comprising:
selecting a core discharge chamber;
selecting a discharge cathode assembly (DCA) from a plurality of different DCAs;
adapting a DCA common interface (CI) to fit between the core discharge chamber and the DCA, wherein the DCA CI is adapted to be fitted with each one of the plurality of different DCAs;
selecting a neutralizer cathode assembly (NCA) from a plurality of different NCAs;
designing an NCA common interface (CI) to fit between the core discharge chamber and the NCA, wherein the NCA CI is adapted to be fitted with each one of the plurality of different NCAs;
selecting an ion optics assembly (IOA) from a plurality of different IOAs;
designing a IOA common interface (CI) to fit between the core discharge chamber and the IOA, wherein the IOA CI is adapted to be fitted with each one of plurality of different IOAs;
assembling the EP rocket engine using the core discharge chamber, DCA, DCA CI, NCA, NCA CI, IOA, and IOA CI.

2. The method of producing an EP rocket engine of claim 1, wherein the DCA is a first DCA, the NCA is a first NCA, the IOA is a first IOA, and further comprising:
connecting the DCA common interface (CI) to the core discharge chamber;
connecting the first DCA to the DCA CI;
connecting the NCA CI to the core discharge chamber;
connecting the first NCA to the NCA CI;
connecting the IOA CI to the core discharge chamber;
connecting the first IOA to the IOA CI.

3. The method of producing an EP rocket engine of claim 2 further comprising:
removing the first DCA from the DCA CI;
connecting a second DCA to the DCA CI, wherein the second DCA is different than the first DCA;
removing the first NCA from the NCA CI;
connecting a second NCA to the NCA CI, wherein the second NCA is different than the first NCA;
removing the first IOA from the IOA CI; and
connecting a second IOA to the IOA CI, wherein the second IOA is different than the first IOA.

4. The method of producing an EP rocket engine of claim 1, further comprising selecting the core discharge chamber based on an operational level.

5. The method of producing an EP rocket engine of claim 4, wherein the operational level is one of a small operating level operating between about a 0.5 kilowatt (kW) to 5.0 kW power level, an intermediate operating level operating between 5kW to 20 kW and, a large operating level operating between 20-100 kW.

6. The method of producing an EP rocket engine of claim 5, wherein when the operational level is a small operating level the discharge chamber has a nominal diameter of 20 centimeters (cm), wherein when the operational level is an intermediate operating level the discharge chamber has a nominal diameter of 40 cm, and wherein when the operational level is a large operating level the discharge chamber has a nominal diameter of 60 cm.

7. The method of producing an EP rocket engine of claim 1, further comprising selecting a core discharge chamber that is a single common core sub-assembly.

8. The method of producing an EP rocket engine of claim 1, wherein the EP rocket engine is formed as a Hall-Effect thruster.

9. The method of producing an EP rocket engine of claim 1, wherein the discharge cathode assembly (DCA) common interface (CI) provides for a common DCA electrical interface, a common DCA mechanical interface, and a common DCA propellant interface, wherein the neutralizer cathode assembly (NCA) common interface (CI) provides for a common NCA electrical interface, a common NCA mechanical interface, and a common NCA propellant interface, and wherein the ion optics assembly (IOA) common interface (CI) provides for a common IOA electrical interface, and a common IOA mechanical interface.

10. The method of producing an EP rocket engine of claim 1, further comprising:
determining if the IOA will be operating with a high total impulse, wherein when the IOA is to be operating with high total impulse, carbon based IOA electrodes are selected; and wherein when the IOA is not to be operating with a high total impulse, metal based IOA electrodes are selected.

11. The method of producing an EP rocket engine of claim 1, wherein the NCA is attached to the core discharge chamber with a flange.

12. The method of producing an EP rocket engine of claim 11, wherein the flange is a vacuum conflat flange with a diameter between two and four inches in diameter.

13. An electric propulsion (EP) rocket engine comprising:
a core discharge chamber;
a neutralizer cathode assembly (NCA);
an discharge cathode assembly (DCA);
an ion optics assembly (IOA);
an NCA common interface (CI) mounted to the core discharge chamber with the NCA mounted to the NCA;
a DCA CI mounted to the core discharge chamber with the NCA mounted to the NCA CI;
an IOA CI mounted to the core discharge chamber with the IOA mounted to the IOA CI.

14. The EP rocket engine of claim 13, wherein the DCA is a first DCA, the NCA is a first NCA, the IOA is a first IOA, and further comprising:
a second DCA;
a second NCA;
a second IOA;
wherein the first DCA is adapted to be removed from the DCA CI and replaced with the second DCA that is different than the first DCA, wherein the first NCA is adapted to be removed from the NCA CI and replaced with the second NCA that is different than the first NCA, and wherein the first IOA is adapted to be removed from the IOA CI and replaced with the second IOA that is different than the first IOA,

15. The EP rocket engine of claim 13, wherein the EP rocket engine is formed as a Hall-Effect thruster.

16. The EP rocket engine of claim 13, wherein the discharge cathode assembly (DCA) common interface (CI) provides for a common DCA electrical interface, a common DCA mechanical interface, and a common DCA propellant interface, wherein the neutralizer cathode assembly (NCA) common interface (CI) provides for a common NCA electrical interface, a common NCA mechanical interface, and a common NCA propellant interface, and wherein the ion optics assembly (IOA) common interface (CI) provides for a common IOA electrical interface and a common IOA mechanical interface.

17. A method, comprising:
executing, on a processor, instructions that cause the processor to perform operations associated with a function, the operations comprising:
selecting a core discharge chamber;
selecting a discharge cathode assembly (DCA) with a DCA common interface (CI) used with the core discharge chamber;
selecting a neutralizer cathode assembly (NCA) with a NCA CI used with the core discharge chamber; and
selecting an ion optics assembly (IOA) with an IOA CI used with the core discharge chamber.

18. The method of claim 17, the operations further comprising:
instructing for the EP rocket engine to be assembled using the core discharge assembly, DCA, the DCA CI, the NCA, the NCA CI, the IOA, and the IOA CI.

19. The method of claim 17, the operations further comprising:
determining if the IOA is to operate with a high specific impulse, wherein when the IOA is to operate with a high specific impulse, further comprising:
selecting an IOA to operate with a high specific impulse, wherein when the IOA is not to operate with a high specific impulse, further comprising:
selecting an IOA to not operate with a high specific impulse.

20. The method of claim 17, the operations further comprising
determining if the IOA is to operate with a high thrust to power, wherein when the IOA is to operate with a high thrust to power further comprising:
selecting carbon based IOA electrodes to operate with a high thrust to power, wherein when the IOA is not to operate with a high thrust to power, further comprising:
selecting metal based IOA electrodes to not operate with a high thrust to power.
